(19) United States
(12) Patent Application Publication
(10) Pub. No.: US 2026/0042071 A1
(43) Pub. Date: Feb. 12, 2026

(54) MIXING SHAFT

(71) Applicant: MASCHINENFABRIK GUSTAV EIRICH GMBH & CO. KG, Hardheim (DE)

(72) Inventors: Thomas LEIBLEIN, Hardheim (DE); Stefan GERL, Werbach (DE); Andreas SEILER, Tauberbischofsheim (DE); Réne SCHWING, Buchen (DE)

(21) Appl. No.: 19/100,254

(22) PCT Filed: Oct. 13, 2023
(86) PCT No.: PCT/EP2023/078454

§ 371 Date: Jan. 31, 2025

(30) Foreign Application Priority Data
Oct. 20, 2022 (DE) 10 2022 127 727.5

(51) Int. Cl. B01F 27/072; B01F 27/07; B01F 27/112; B01F 27/191; B01F 27/2121

(52) U.S. Cl. CPC B01F 27/0724; B01F 27/071; B01F 27/0722; B01F 27/112; B01F 27/191; B01F 27/2121

(57) ABSTRACT

A mixing shaft has a tool holder rotatable about a tool axis and at least one mixing blade. The tool holder includes at least one recess in which a mixing blade portion of the at least one mixing blade is received. A clamping member inserted into the recess is configured to fix the mixing blade portion in the recess. The recess includes a first and a second recess portion. The mixing blade portion is arranged in the first recess portion and the clamping member is arranged at least partly in the second recess portion, wherein the first recess portion and the second recess portion are arranged adjacently in one plane extending perpendicularly to the tool axis.

The present invention relates to a mixing shaft having a tool holder rotatable about a tool axis and at least one mixing blade, wherein the tool holder comprises at least one recess in which a mixing blade portion of the at least one mixing blade is received. For fixing the mixing blade portion in the recess, a clamping member is configured to be inserted into the recess. For this purpose, the recess is divided into a first and a second recess portion, wherein the mixing blade portion is arranged in the first recess portion and the clamping member is arranged at least partially in the second recess portion.

Mixing shafts of the aforementioned type are used in various mixers known from the prior art. Thereby, the mixing shaft is typically arranged approximately perpendicular to a bottom of the mixing vessel therein. To mix a material to be mixed in the mixer, a tool holder of a mixing shaft often comprises a plurality of mixing blades arranged one after the other in a plurality of planes along the tool axis and extending radially outwardly from the tool axis of the mixing shaft.

If the mixing shaft is rotated about the tool axis during operation of the mixer, the material to be mixed flows past the mixing blades, so that they are subject to wear and have to be replaced at regular intervals. It has been shown that mixing blades covered by a higher layer height of material to be mixed, i.e. those which are arranged close to the bottom of the container, wear significantly faster than mixing blades which are arranged close to the surface of the material to be mixed, i.e. further away from the bottom of the mixing container.

It is therefore already known from the prior art to be able to remove the mixing blades individually from the tool holder and replace them with new mixing blades. The aim is to replace the mixing blades as quickly and easily as possible.

For this purpose, it is known from the prior art to clamp the mixing blades with a clamping device in the recess of the tool holder. A corresponding clamping device is known, for example, from EP 3 439 774 B1. In this case, when viewed in the direction of the tool axis, a first recess portion, in which a portion of the mixing blade is located, is arranged above a second recess portion, in which a clamping member is inserted for fixing the mixing blade. The clamping member consists of several components and is fixed in the recess by means of several screws.

However, this complex clamping system can only be mounted and dismounted with great effort. In addition, the clamping members are sometimes difficult to access due to their arrangement below or above the mixing blade, and in proportion they are exposed to high wear by the material to be mixed flowing past. Finally, with this clamping system, the mixing blade, which is arranged closest to the bottom of the container and which, at best, is guided as close as possible to the bottom of the container, must also be adapted.

The object of the present invention is therefore to provide a mixing shaft with a tool holder which allows particularly simple replacement of the mixing blades.

The object underlying the invention is solved by a mixing shaft of the type mentioned at the outset, wherein the first recess portion and the second recess portion are arranged adjacently in one plane which extends perpendicularly to the tool axis.

In other words, the clamping member is arranged in one plane with the mixing blade portion when viewed in the direction of the tool axis, rather than sequentially along the tool axis as in prior art clamping systems.

This offers the advantage that the clamping member is easily accessible and is not arranged below a mixing blade. Tools required for replacement can therefore be inserted without colliding with the mixing blade.

In addition, only one recess needs to be adapted in the tool holder in the circumferential direction and not two recesses arranged one above the other. This simplifies the removal of the mixing blades from the tool holder as well as the assembly of the mixing blades in the tool holder. Overall, these advantages lead to a more efficient replacement of the mixing blades compared to mounting options known from the prior art.

In one embodiment, the mixing shaft is configured to be rotated in a rotational direction about the tool axis, wherein the second recess portion is arranged downstream of the first recess portion in the rotational direction.

This has the advantage that the clamping member is located in the flow shadow of the mixing blade and is thus effectively protected against wear. As a result of the flow over the mixing blade, there is no or only a very slight incident flow through the material to be mixed.

In a further embodiment, the clamping member comprises a coating against corrosion, wherein preferably the coating is a cadmium or phosphate coating. This measure also extends the service life of the clamping member. In addition, removal of the clamping member is simplified, since adhesion of the clamping member is reduced even after a long period of installation and operation of the mixer.

In another embodiment, the clamping member is fixed to the tool holder in the recess with the aid of a screw, wherein the screw preferably extends through a through hole of the clamping member into a threaded hole arranged in a rear wall of the recess in the tool holder. Preferably, the clamping member is connected to the tool holder radially with respect to the tool axis. The clamping system according to the invention is thus fastened by only a single screw, which allows rapid replacement of the mixing blades.

In a further embodiment, a release device is configured to release the clamping member from the recess.

Such a release device may be, for example, a pressure screw that is engaged with a corresponding forcing-off thread implemented in the through hole of the clamping member. It is self-evident that the forcing-off thread and the pressure screw comprise a larger diameter than the screw adapted for fixing the clamping member in the recess, so that the fixing screw is guided through the forcing-off thread for fixing the clamping member in the recess. Once the fastening screw for removing the mixing blade is removed, the pressure screw is screwed into the forcing-off thread and exerts a force on the rear wall of the recess so that the clamping member is released from it.

Alternatively, an ejector device can be fastened in the through hole of the clamping member as a release device, with which the clamping member is ejected from the recess.

However, these solutions have the disadvantage that impurities can build up in the forcing-off thread and the threads therefore have to be regularly recut, which requires an additional work step.

Preferably, therefore, in one embodiment, the release device is positively or integrally connected to a portion of the screw, wherein the release device is arranged between the clamping member and the rear wall of the recess. The one-piece connection is thereby preferably provided by a welded or bonded connection.

By providing a release device on the screw for fastening the clamping member, the additional working step for removing the clamping member, for example by means of a pressure screw or an ejector device, is eliminated. Unscrewing the screw results in immediate release of the clamping member in the recess due to the release device.

In a further embodiment, the release device is shaped as a disk, wherein preferably an outer circumferential surface of the disk is shaped round and without edges. This ensures that the release device can also move if material to be mixed has penetrated between the release device and an inner proportion of the recess. This counteracts jamming of the release device.

In particular, in a further embodiment, the release device is arranged at a distance from the clamping member to prevent jamming with the screw.

In a further embodiment, a seal, preferably made of plastic material and particularly preferably made of polyurethane, is provided, which is arranged between the release device and the rear wall of the recess on a portion of the screw in such a way that the threaded opening in the rear wall of the recess is sealed by the screw and the seal in the mounted state of the clamping member. The seal thus protects the threaded opening in the recess of the tool holder from contamination by penetrated material to be mixed, which in turn simplifies removal of the clamping member and thus of the mixing blade.

In a preferred embodiment, the clamping member is formed as a one-piece member. Consequently, to replace the mixing blade several components of the clamping member do not require release, allowing the replacement to proceed more quickly. A one-piece connection is understood to mean a connection that cannot be disconnected non-destructively. The clamping member may, for example, be manufactured in a single casting or welded together from several components.

It is self-evident, however, that the clamping member according to the invention can also be designed in two or more parts.

In a further embodiment, the clamping member and the mixing blade portion and/or the mixing blade portion and the tool holder are configured in such a way that the clamping member and the mixing blade portion and/or the mixing blade portion and the tool holder form a positive connection in the recess. This has the advantage that the mixing blade portion is not only force-locked in the recess by means of the clamping member, but also that a positive connection ensures that the mixing blade portion cannot be removed from the recess without removing the clamping member. The clamping member is thus mechanically obstructing the mixing blade portion. Alternatively, or additionally, the mixing blade portion is positively connected to the tool holder, so that this connection also contributes to the secure fixture of the mixing blade.

The positive connection between the mixing blade portion on the one hand and the clamping member or tool holder on the other hand is preferably provided by a pin connection. It is self-evident that alternatively a triangular connection, an L-shaped connection or other connection geometries can also be used for a positive connection.

In particular, in a further embodiment, the clamping member is arranged between the mixing blade portion and a side wall of the second recess portion opposite the mixing blade portion, wherein the clamping member is supported by both the mixing blade portion and the side wall, wherein both the clamping member and the mixing blade portion and/or the side wall comprise mutually corresponding wedge surfaces. In the present invention, a wedge surface is understood to be a surface which comprises a wedge-shaped geometry in a plane perpendicular to the tool axis. The wedge surfaces have the advantage that the mixing blade portion is not only held frictionally by clamping in the recess, but there is also a positive fit between the mixing blade portion and the clamping member.

If the clamping member has a multi-part design, the mutually corresponding wedge surfaces can additionally be realized between the individual components of the clamping member, as well.

In a further embodiment, the clamping member comprises a lubrication device, wherein the lubrication device comprises a receptacle for lubricant as well as a lubrication channel by means of which lubricant can be introduced from the receptacle into the recess. By means of the lubrication device, the recess can be protected with grease or another filling medium against the penetration of material to be mixed or water, which acts on the mixing shaft, for example, during operation of the mixer or during pressure cleaning of the mixer.

In particular, in one embodiment, the clamping member comprises a first side and a second side arranged one after the other in the direction of the tool axis. Here, a first portion of the lubrication channel is shaped as a recess and preferably as a groove on the first side and/or the second side of the clamping member, and a second portion of the lubrication channel provides a connection between the receptacle and the first portion of the lubrication channel. In other words, this arrangement transports lubricant from the receptacle to the contact surfaces of the clamping member with the recess, that is, the first and/or second side. It is self-evident, therefore, that in one embodiment the first portion comprises at least two subsections, wherein one subsection is arranged on the first side and the other subsection is arranged on the second side.

In another embodiment, the clamping member comprises an outer portion and an inner portion, wherein the outer portion is more distant from the tool axis than the inner portion of the clamping member, wherein the lubrication channel is arranged in the outer portion of the clamping member so that only the outer portion of the clamping member and a corresponding portion of the recess are supplied with lubricant. Preferably, the outer section comprises a dimension in a radial direction to the tool axis which is at most as large as a dimension of the inner section in the radial direction. In particular, in a further embodiment, the first portion of the lubrication channel extends from a first lateral surface of the clamping member in contact with the mixing blade portion in the recess to a second lateral surface of the clamping member opposite the first lateral surface. This results in the lubricant being effectively distributed throughout the expansion of the clamping member in the circumferential direction in the recess.

The arrangement of the lubrication channel in the outer section of the clamping member has the advantage that, although the lubricant achieves a lubricating effect outwardly, the inner section of the clamping member is only acted upon by a small amount of lubricant, or none at all, and thus the screw connection of the clamping member to the tool holder is not affected. At the same time, the arrangement of the first lubrication channel section in the outer section of the clamping member according to the invention also leads to a saving of lubricant.

In a further embodiment, at least one protective element is provided which is arranged in the second recess portion and comprises a greater distance from the tool axis than the clamping member, so that the clamping member is covered, wherein the protective element closes the second recess portion at least partially, preferably completely. It is self-evident that a plurality of protective elements may also be provided, for example covering individual holes such as the lubricant receptacle or the screw head in the through hole of the clamping member. The protective element thus additionally protects the clamping member, in particular the screw heads and the lubricant receptacle, against the penetration of moisture or dirt by the material to be mixed or cleaning fluids and thus extends the service life of the clamping member as well as its fastening means.

Further advantages, features and possible applications will be apparent from the following description of a preferred embodiment and the accompanying figures. Identical components are marked with the same reference numbers.

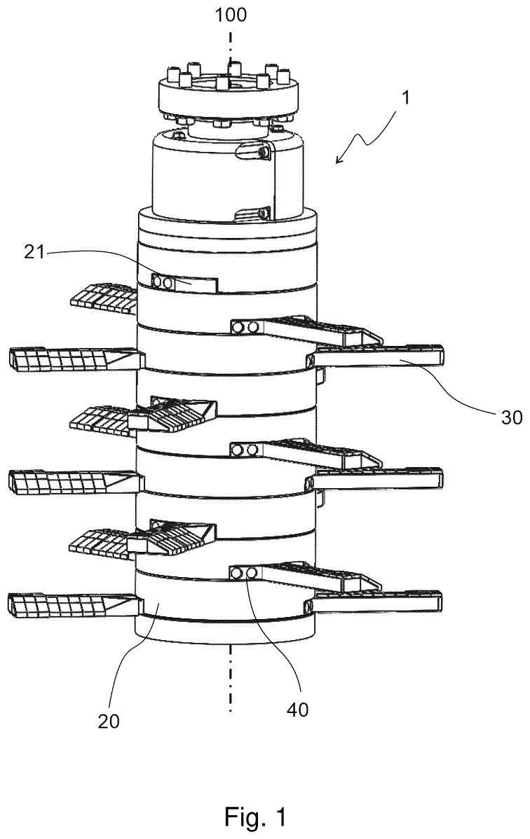

FIG. 1 shows a perspective view of an embodiment of the mixing shaft according to the invention.

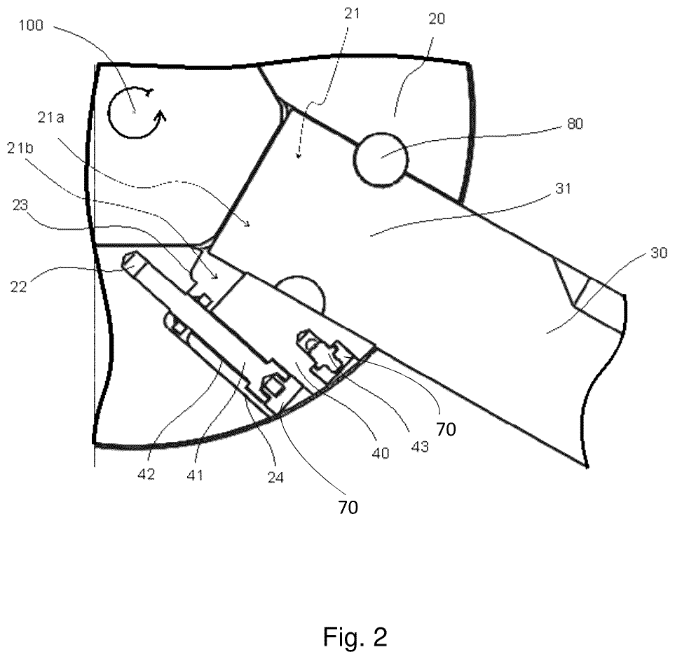

FIG. 2 shows a partial cross-section through the mixing shaft shown in FIG. 1 perpendicular to the tool axis.

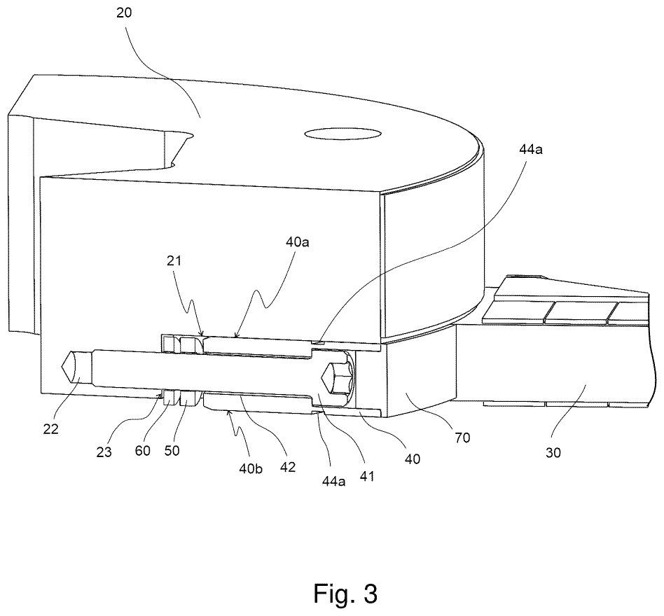

FIG. 3 shows a partial longitudinal section of a further embodiment of the mixing shaft according to the invention parallel to the tool axis.

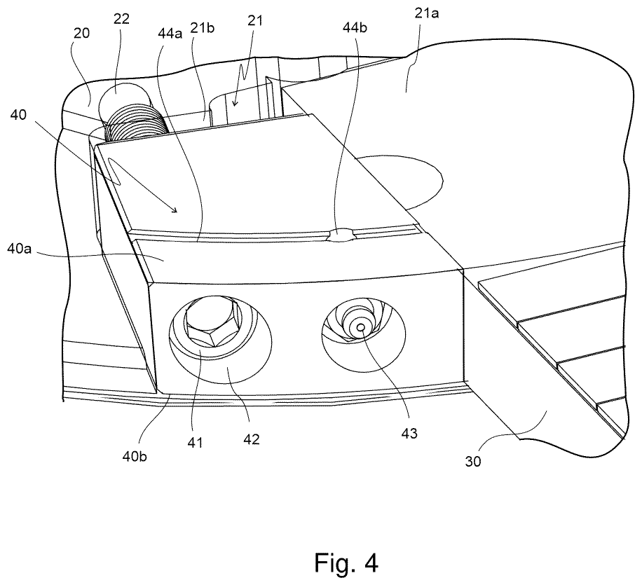

FIG. 4 shows a perspective view of a section of the mixing shaft shown in FIG. 1.

The mixing shaft 1 shown in the figures comprises a tool holder 20 rotatable about a tool axis 100 and a plurality of mixing blades 30. In the tool holder 20, recesses 21 are provided in which a mixing blade portion 31 of the mixing blades 30 is arranged together with a clamping member 40. The clamping member 40 serves to fix the mixing blade portion 31 in the recess 21.

The detailed structure of the fixing of the mixing blade portion by means of the clamping member 40 is shown in particular in FIGS. 2 and 3.

As can be derived from FIG. 2, the recess 21 consists of a first recess portion 21a and a second recess portion 21b. In the first recess portion 21a, the mixing blade portion 31 of the mixing blade 30 is received. In the second recess portion 21b, the clamping member 40 is arranged. As can be seen in particular from FIG. 2, the clamping member 40 and the mixing blade portion 31 are arranged on one plane extending perpendicularly to the tool axis 100.

The clamping member 40 is force-fitted within the second recess portion 21b by means of a screw 41. For this purpose, the screw 41 is passed through a through hole 42 of the clamping member 40 and screwed into a threaded hole 22 arranged in a rear wall 23 of the recess 21.

When the clamping member 40 is disposed and fixed in the second recess portion 21b, the clamping member 40 is disposed between the mixing blade portion 31 and a side wall 24 of the recess 21 so as to clamp the mixing blade portion 31 in the first recess portion 21a so that the mixing blade 30 is securely held in the tool holder 20.

For additional fixation of the mixing blade portion 31 in the first recess portion 21a, a pin 80 is additionally provided to form a positive connection between the tool holder 20 and the mixing blade portion 31.

When the mixing shaft shown in FIG. 1 is rotated counterclockwise, the second recess portion 21b is located downstream of the first recess portion 21a in the direction of rotation. As a result, the second recess portion 21b is located in the flow shade of the mixing blade 30, so that the clamping member 40 is exposed to less wear caused by material to be mixed that flows past. This in turn increases the service life of the clamping member 40.

However, since the mixing blades 30 are likewise subject to wear due to the material to be mixed that flows past, which wear additionally varies depending on the position of the mixing blades 30 along the tool axis 100, the mixing blades 30 must be replaced individually. In order to dismount the mixing blade 30 from the tool holder 20, the clamping member 40 must be removed.

To release the clamping member 40 from the second recess portion 21b and thereby replace the mixing blade 30, the screw 41 comprises a release device 50 shown in FIG. 3, that is integrally connected to the screw 41 and arranged between the clamping member 40 and the rear wall 23 of the recess 21.

In detail, the release device 50 is arranged as an annular washer on a threaded section of the screw 41 in such a way that there is a distance between the release device 50 and the clamping member 40 to prevent jamming of the screw 41 with the clamping member 40 on the one hand and with any material to be mixed that may have penetrated on the other hand.

If the screw 41 is unscrewed from the threaded opening 22 of the rear wall 23 of the recess 21, this results in the clamping member 40 being released, thus eliminating the need for an additional operational step for removing the clamping member 40 from the recess 21.

To protect the threaded opening 22 of the recess 21 from contamination by the material to be mixed, a seal 60 is provided which is arranged between the release device 50 and the rear wall 23 of the recess 21 and covers the threaded opening 22 together with the screw 41 and the release device 50. The seal 60 is also shaped as an annular disc and is made, for example, of polyurethane or another sealing material.

For additional sealing of the recess 21 towards the material to be mixed, the clamping member 40 further comprises a lubricating device, which is shown in particular in FIG. 4. The lubrication device consists of a receptacle 43 for lubricant and a lubrication channel, which consists of first sections 44a and a second section 44b.

Thereby, the clamping member 40 is configured to have a first side 40a and a second side 40b, which are arranged one after the other in the direction of the tool axis 100. The first sections 44a of the lubrication channel are shaped as a groove on the first side 40a and the second side 40b of the clamping member (see also FIG. 3). The second section 44b of the lubrication channel forms a connection between the lubricant receptacle 43 and the first sections 44a of the lubrication channel. The first sections 44a of the lubrication channel can also be continued, if necessary, in particular for sealing purposes, onto the lateral surfaces of the clamping member 40, which extend parallel to the tool axis.

As can be derived in particular from FIG. 4, the lubrication channel is arranged in an outer section of the clamping member 40 which is more distant from the tool axis 100 than an inner section of the clamping member 40. A dimension of the outer section of the clamping member 40 in radial direction to the tool axis 100 is thereby equal to a dimension of the inner section in radial direction. This means that only the outer section of the clamping member 40 and a corresponding section of the recess 21 being supplied with lubricant, so that lubricant is saved. At the same time, the lubrication of the clamping member 40 leads to a sealing of the second recess portion 21b against outside influences. These include, in particular, the inflow of material to be mixed, but also influences acting on the mixing shaft, for example during high-pressure cleaning of the latter.

In addition, the screw 41 fixing the clamping member 40 in the second recess portion 21b is also effectively protected against outside influences, so that the clamping member 40 can be loosened by simple means even after a longer service life of the mixing shaft 1 and the mixing blade 30 can be replaced particularly easily.

Finally, a protective element 70 is further provided, which is likewise arranged in the second recess portion 21b and comprises a greater distance from the tool axis 100 than the clamping member 40. The protective element 70 is configured in such a way that it covers a radially outer side of the clamping member 40 and additionally protects the latter from outside influences.

Alternatively, protective elements 70 can also be provided in a radially outer region of the clamping member 40, covering the lubricant receptacle 43 and the through hole 42 only, for example in the form of one or more plugs (see FIG. 2).

### REFERENCE NUMBERS

1 mixing shaft
20 tool holder
21 recess
21a first recess portion
21b second recess portion
22 thread opening
23 back wall
24 side wall
30 mixing blade
31 mixing blade portion
40 clamping member
40a first side of clamping member
40b second side of clamping member
41 screw
42 through hole
43 lubricant channel
44a first section of lubricant channel
44b second section of lubricant channel
50 release device
60 seal
70 protective element
80 pin
100 tool axis

1. A mixing shaft comprising a tool holder rotatable about a tool axis and at least one mixing blade, wherein the tool holder comprises at least one recess in which a mixing blade portion of the at least one mixing blade is received, wherein a clamping member inserted into the recess is configured to fix the mixing blade portion in the recess, wherein the recess comprises a first and a second recess portion, wherein the mixing blade portion is arranged in the first recess portion and the clamping member is arranged at least partially in the second recess portion, and wherein the first recess portion and the second recess portion are arranged adjacently in one plane extending perpendicularly to the tool axis.

2. The mixing shaft according to claim 1, wherein the mixing shaft is configured to be rotated in a rotational direction about the tool axis, wherein the second recess portion is arranged downstream of the first recess portion in the rotational direction.

3. The mixing shaft according claim 1, wherein the clamping member comprises a coating against corrosion.

4. The mixing shaft according to claim 1, wherein the clamping member is fixed to the tool holder in the recess by a screw wherein the screw extends through a through hole of the clamping member into a threaded hole arranged in a back wall of the recess in the tool holder.

5. The mixing shaft according to claim 4, wherein a release device is provided to release the clamping member from the recess wherein the release device is arranged between the clamping member and the rear wall of the recess.

6. The mixing shaft according to claim 5, wherein the release device is shaped as a disk.

7. The mixing shaft according to claim 5, wherein the release device is arranged at a distance from the clamping member.

8. The mixing shaft according claim 5, wherein a seal is provided, which is arranged between the release device and the rear wall of the recess on a portion of the screw in such a way that the threaded opening in the rear wall of the recess is sealed by the screw and the seal in the mounted state of the clamping member.

9. The mixing shaft according to claim 1, wherein the clamping member is formed as one-piece member.

10. The mixing shaft according to claim 1, wherein the clamping member and the mixing blade portion and/or the mixing blade portion and the tool holder are configured in such a way that the clamping member and the mixing blade portion and/or the mixing blade portion and the tool holder form a positive connection in the recess.

11. The mixing shaft according to claim 1, wherein the clamping member is arranged between the mixing blade portion and a side wall of the second recess portion opposite the mixing blade portion, wherein the clamping member is supported both on the mixing blade portion and on the side wall, wherein both the clamping member and the mixing blade portion and/or the side wall comprise wedge surfaces corresponding to each other.

12. The mixing shaft according to claim 1, wherein the clamping member comprises a lubrication device, wherein the lubrication device comprises a receptacle for lubricant and a lubrication channel by which lubricant can be introduced from the receptacle into the recess.

13. The mixing shaft according to claim 12, wherein the clamping member has a first side and a second side arranged one after the other in the direction of the tool axis, wherein a first portion of the lubrication channel is shaped as a recess and as a groove on the first side and/or the second side of the clamping member, and a second portion of the lubrication channel provides a connection between the receptacle and the first portion of the lubrication channel.

14. The mixing shaft according to claim 13, wherein the clamping member comprises an outer portion and an inner portion, wherein the outer portion is more distant from the tool axis than the inner portion of the clamping member, wherein the lubrication channel is arranged in the outer portion of the clamping member so that only the outer portion of the clamping member and a corresponding portion of the recess are supplied with lubricant, wherein the outer portion comprises an expansion in a radial direction to the tool axis which is maximally as large as an expansion of the inner portion in the radial direction, wherein the first portion of the lubrication channel extends from a first lateral surface of the clamping member which is in contact with the mixing blade portion in the recess to a second lateral surface of the clamping member which is opposite to the first lateral surface.

15. The mixing shaft according to claim 1, wherein at least one protective element is provided, which is arranged in the second recess portion and comprises a greater distance from the tool axis than the clamping member, so that the clamping member is covered at least section-wise, wherein the protective element closes the second recess portion at least partially.

16. The mixing shaft according to claim 3, wherein the coating is a cadmium or phosphate coating.

17. The mixing shaft according to claim 5, wherein the release device is positively or integrally connected to a portion of the screw.

18. The mixing shaft according to claim 6, wherein an outer peripheral surface of the disk is shaped round and without edges.

19. The mixing shaft according to claim 14, wherein the outer portion comprises an expansion in a radial direction to the tool axis which is maximally as large as an expansion of the inner portion in the radial direction.

20. The mixing shaft according to claim 14, wherein the first portion of the lubrication channel extends from a first lateral surface of the clamping member which is in contact with the mixing blade portion in the recess to a second lateral surface of the clamping member which is opposite to the first lateral surface.
